(19) United States
(12) Patent Application Publication
(10) Pub. No.: US 2014/0244365 A1
(43) Pub. Date: Aug. 28, 2014

(54) TOLL APP SYSTEM

(71) Applicant: DGRT Software LLC, Tampa, FL (US)

(72) Inventors: Doug Price, Tarpon Springs, FL (US); Malchiel Doraisamy, Sarasota, FL (US); Gilbert R. Bailie, Tampa, FL (US)

(73) Assignee: DGRT Software LLC, Tampa, FL (US)

(21) Appl. No.: 14/135,853

(22) Filed: Dec. 20, 2013

Related U.S. Application Data
(60) Provisional application No. 61/747,253, filed on Dec. 29, 2012.

(51) Int. Cl. G07B 15/00; G06Q 20/32; G07B 15/02; H04W 4/02

(52) U.S. Cl. CPC G07B 15/00; H04W 4/023; G06Q 20/3224; G07B 15/02
USPC 705/13

(57) ABSTRACT

The Toll App uses the user's smart phone to determine when the user crosses a toll zone. The app then automatically makes the correct payment for using the toll zone. The Toll App uses the phone's storage media to store toll zones defined on a web site by the toll operator. The Toll App uses the user's payment vehicle such as a credit card to make the payment. The Toll App web site provides a user interface for the toll operator to create and store toll zones on a database and those toll zones are sent to the storage media on the user's phone.

### BACKGROUND

1. Field of Invention

This invention relates to the process of a registered toll customer paying tolls using their mobile device. An example of a customer using the mobile toll app is where the customer has downloaded the mobile toll app to their mobile device and upon entering a toll area; their mobile device would activate the mobile toll app at that particular GPS location. The mobile toll app would also notify the tolling authority that it was a registered mobile toll customer and was tracking the toll cost for that vehicle. The mobile device would activate that exact GPS location and charge the customer's account for the toll fee transaction.

### Cost to the Tolling Authority

This mobile toll app process eliminates the need and expense for tolling authority to collect cash tolls and the need to provide window decals for mobile app customers.

### Benefit to the Customer

The mobile toll app benefits the customer as the customer can download the mobile toll app from one of the online app stores such as iTunes and Android Market or the tolling authority's website. The customer completes the customer information setup and the mobile toll app is available for the customer to use. The mobile toll app provides the customer with the ability to use the mobile toll app in any vehicle, their own, borrowed and rental cars on any system that they are registered on. The customer can register in several different states using the mobile toll app. This feature is useful for customers who frequently travel to other areas and use rental cars for transportation.

The customer will be able to download from the mobile toll app's website reports showing their toll expense for an individual toll, a particular trip or time period. The ability to consolidate toll expenses for expense reports is available.

The mobile toll app can also be used by parking facilities to collect parking fees (Note to Gil—keep it as general as possible. Say “collect parking fees.” Don't say “based on the duration of use instead of distance travelled.” If you provide this unnecessary detail, then another company would create the same app and collect parking fees based on some other criteria and since our patent was based on duration and theirs is based on something else, they would get away with it. If you say our app collects parking fees without specifying the criteria, our patent is more general).

### Cost to the Customer

The initial cost to the customer will vary depending on the requirements of the particular tolling authority that they are registering with. The cost of the tolls will depend on the toll fees that the tolling authority charges for the use of their roads.

The cost by parking facilities will vary based on the fee structure and the customers individual parking agreement.

Customer Use of the Mobile toll App.

The customer has the ability to activate and deactivate the mobile toll app. The mobile toll app features a warning notice on the mobile device when the customer is approaching the toll area. This provides the customer the ability to turn off the mobile tolling app in the event that the customer is a passenger in a vehicle that is not theirs.

The customer also can use the mobile tolling app to place a 911 or other calls set up for mechanical emergencies. These calls will provide the person receiving the calls with the GPS location of the customer.

2. Description of Prior Art

Patent U.S. Pat. No. 8,280,791 B2 describes an invention by John Potts Davis III (Dec. 8, 2009) describes a process for paying tolls. However, this invention describes a system where a smart automobile is required and requires specific transceivers to read the signal from the smart automobile. Further, a response from the transceivers is required for a payment to be made.

As this patent is requires a smart automobile, requires the installation of transceivers and requires a response from the transceivers and our system uses a phone (not a vehicle), does not require any transceiver, our system is clearly different.

In conclusion, insofar as we are aware, no process has been developed where a toll can be paid, automatically, using a smart phone without requiring transceivers.

### SUMMARY

The Toll App allows customers to drive on a toll road and enjoy the convenience of having the toll paid for automatically, simply by having their phone with the Toll App Software in the car.

The toll operators can set up toll zones without requiring installation of any physical structure.

The customer will also have the benefit of other reports such as mileage reimbursement forms generated from the data captured by the Toll App.

### DRAWINGS

FIG. 1—The splash screen

FIG. 2—The login page that comes up after the splash screen

FIG. 3—The Home tab screen after login

FIG. 4—The Map tab screen

FIG. 5—The Reports tab screen

FIG. 6—The Settings tab screen

FIG. 7—Toll App Web Site Login Page

FIG. 8—Toll zone creation and management

FIG. 9—Top Navigation

FIG. 10—User Management

FIG. 11—Toll Set up

### DESCRIPTIONS

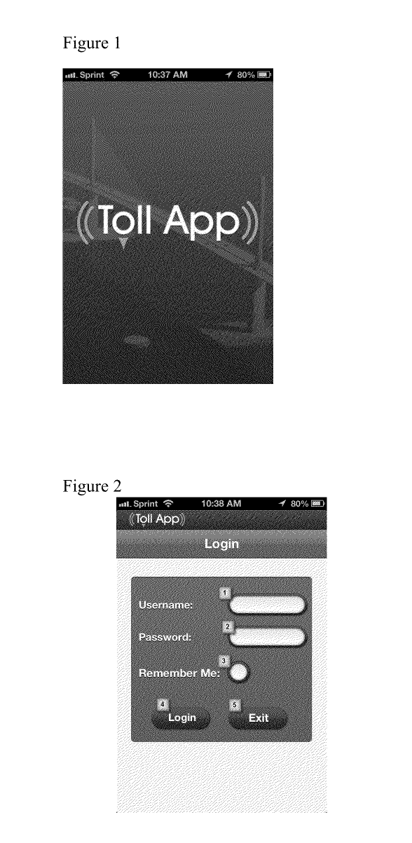

### FIG. 1 Overall System.

FIG. 2—The Login Page that comes up after the Splash Screen

Element 1—This is the field for the username, which is your email address

Element 2—This is the field for the password associated with the username

Element 3—This is a checkbox for remember me, which will remember your username and password.

Element 4—This is the login button that will check the username and password and log the user in.

Element 5—This is a cancel button. Pressing it closes the app to the background.

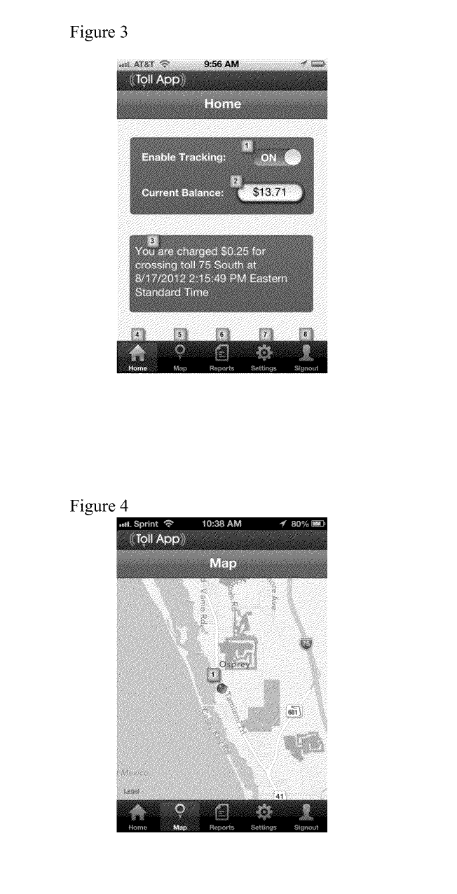

FIG. 3—The Home Tab Screen after Login

Element 1—This is a toggle to determine whether or not to track a user's location.

Element 2—This is the current balance on the user's account.

Element 3—This is information on the most recent charge to the user.

Element 4—This is a tab to get back to this home screen.

Element 5—This is a tab to get to the map screen. Element 6—This is a tab to get to the reports screen. Element 7—This is a tab to get to the settings screen. Element 8—This is a tab to log out of the current user's account

### FIG. 4—The Map Tab Screen

Element 1—This is the indicator of the user's position on the map.

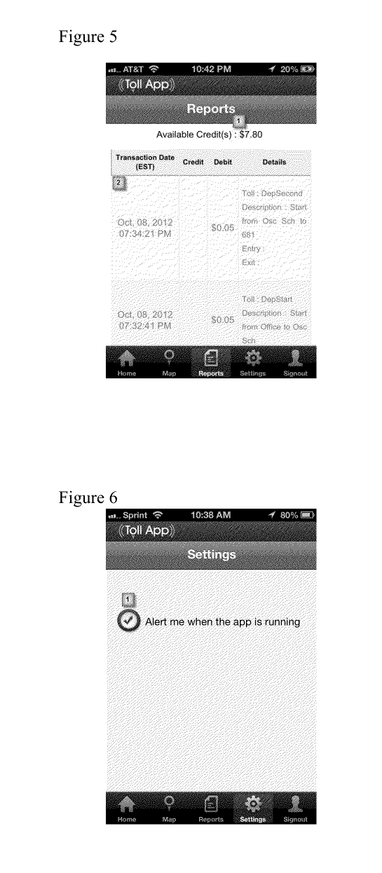

### FIG. 5—The Reports Tab Screen

Element 1—This is the current balance for the user's account.

Element 2—This is a table of information regarding all of the charges to the user.

### FIG. 6—The Settings Tab Screen

Element 1—This is a checkbox for the app to alert the user that the app is still running when it is not in the foreground.

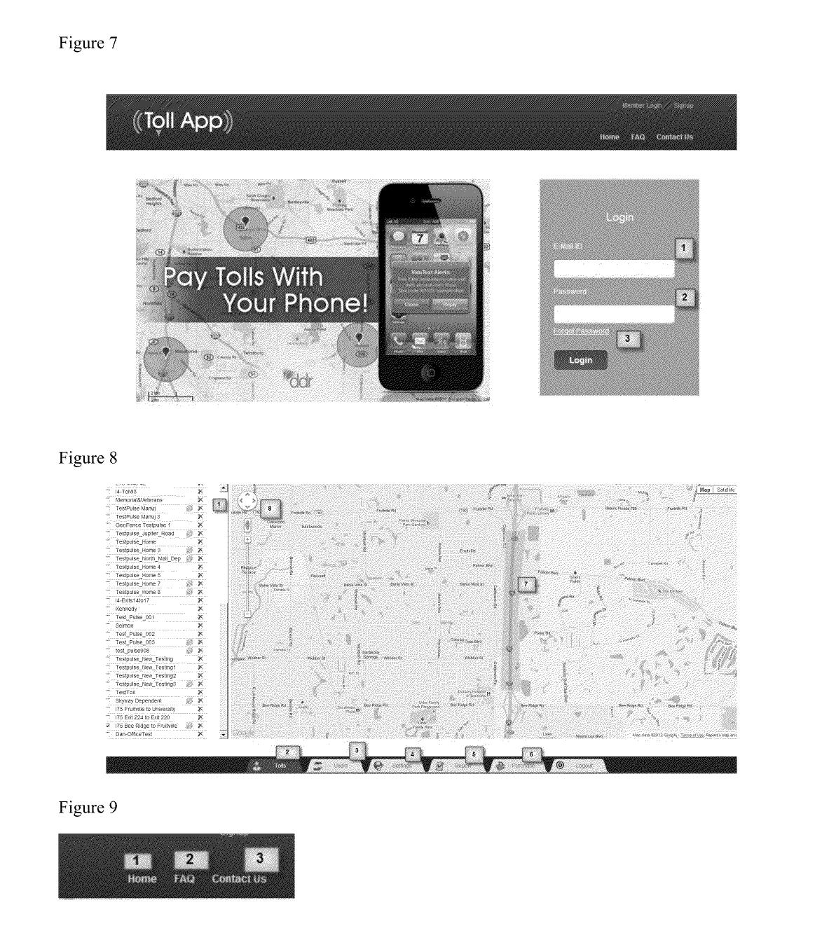

FIG. 7—Toll App Web Site Login Page El 1—User Enters their Login ID

El 2—User enters their password

El 3—User retrieves their password

### FIG. 8—Toll Zone Creation and Management El 1—List of Existing Toll Zones

El 2—Toll creation and management tab

El 3—User management tab

El 4—Settings Tab El 5—Report Tab

El 6—Purchase Tab

### FIG. 9—Top Navigation

El 1—Home page link

El 2—Frequently asked questions link

El 3—Contact us link

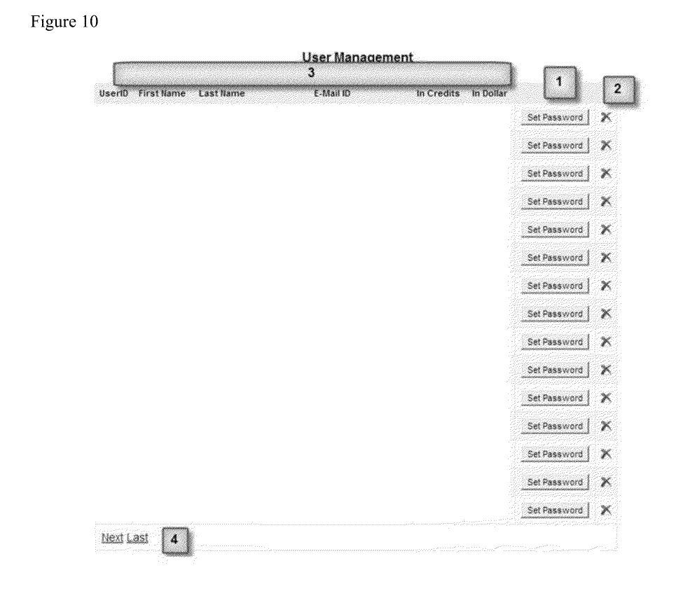

### FIG. 10—User Management

El 1—Set user password

El 2—Delete user

El 3—User information

El 4—Navigation

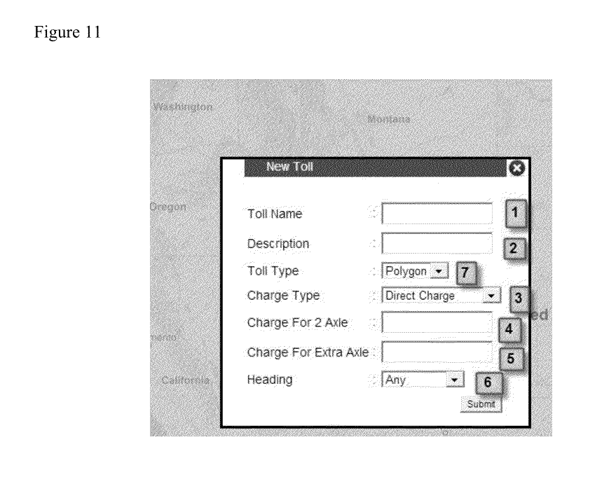

### FIG. 11—Toll Set Up El 1—Toll Name

El 2—Toll Description

El 3—Charge Type (Direct Charge, dependent on access route)

El 4—Charge for 2 axles

El 5—Charge for additional axles

El 6—Heading Rule (charge if only north bound, etc.)

### Advantages

There are several advantages from the use of the Toll App
a) More Convenience: The user does not need to stop at a toll booth and pay the toll manually. The user can just drive through the toll zone.
b) Easy to Pay: The user does not need to keep cash and change on hand to make payments. The user can just drive through and the toll zone and the correct toll amount is automatically paid.
c) Easier record keeping: The user does not need to keep records of their toll payments. The

Toll App automatically sends an email to the user with their payment information, date of payment and name of the toll that they paid for.
d) Portability when travelling: The user does not need to remove a Transponder from their car to a rental car during travelling. When the user uses a rental car or borrowed car, the user just needs to have their phone with them in order to make the payment for tolls.
e) More privacy: The user does not need to disclose private information to the government in order to make electronic payments for their tolls.
f) Reduced construction costs: The toll operator does not need to construct expensive toll booths to collect toll payments. The operator creates a virtual toll zone using the Toll App Web Site.
g) Reduced operating costs. The toll operator does not need to reconcile payment received in one jurisdiction from a drive from a foreign jurisdiction. Toll App automatically sends the correct money to the correct tolling operator regardless of which zone is crossed.

### Operation

1. User begins use of the Toll App searching for the app from the Apple App Store and Google Play Store.

2. User downloads app

3. User installs App

4. User launches App

5. User creates an account

6. User adds their credit card information to the account

7. User takes the phone with the app with them when they travel

8. User crosses a toll zone

9. App will charge the user's account

10. App will inform the user of the charge

11. When the user's balance drops below a certain dollar amount, app will prompt user to make another payment.

### Conclusions, Ramifications and Scope

Accordingly, the reader will see that the Toll App can be used to pay for tolls safely and conveniently. Toll App can be used by private car owners and can also be used by fleets. Toll App affords greater privacy to the end user and reduces construction costs which in turn reduces the environmental impact of traditional toll zone construction.

Toll App facilitates the interoperability between state agencies so that drivers from one state can easily travel to other states and the monies paid by that driver is accurately remitted back to the drivers home jurisdiction.

Toll App can be used nationwide and can also be used worldwide because it is deployed on smart phones that are universally available.

Toll App will save toll operators money by reducing the cost of transponder manufacturing, distribution and disposal.

What is claimed is:

1. A system where a user pays for their tolls using a smart phone with the Toll App Software, where, without requiring transceivers at the toll plaza, said software has the means to
a. Locate the user in relation to a toll zone
b. Determine when the user crosses the toll zone
c. Pay the toll
d. Send the monies paid to the toll operator
e. Record the money paid, the date of payment and the name of the toll zone
f. Send the information recorded in (e) above, to the user,

2. A system as defined in claim 1 wherein the toll operator can create a toll zone by using their computer where
a. Where the toll operator has access to a web site
b. Where each toll zone is stored in a database
c. Where each toll zone has a method of communicating the toll zones to the software on the user's smart phone
d. Where the web site has the means to send information to and receive information from the operator's existing back office toll management software
e. Where the monies paid by the user is automatically distributed to the appropriate toll operators

3. A system as defined in claim 1 wherein a payment is made only when the user meets the directional rule
for that toll zone. In other words, if the toll is only payable when the driver is driving south on a road, then the payment is made only when the driver is driving south and is not paid when the driver is driving north through the toll zone.

4. A system as defined in claim 1 wherein a payment can be required only if a preceding toll zone had been crossed. In other words, if a toll is only payable if the driver had entered the zone from a specific access route, and not charged if the driver had entered the zones from other routes, then the payment would be made only if said conditions were met.

5. A system as defined in claim 1 wherein the user is informed via their phone when their balance in their account drops below a certain level.
